(19) United States
(12) Patent Application Publication
(10) Pub. No.: US 2020/0041854 A1
(43) Pub. Date: Feb. 6, 2020

(54) DISPLAY DEVICE

(71) Applicant: Samsung Display Co., LTD., Yongin-si (KR)

(72) Inventor: Dong Hee Shin, Asan-si (KR)

(21) Appl. No.: 16/389,887

(22) Filed: Apr. 19, 2019

(30) Foreign Application Priority Data
Aug. 3, 2018 (KR) 10-2018-0090845

(51) Int. Cl. G02F 1/1362; G02F 1/1339; G02F 1/1343

(52) U.S. Cl. CPC G02F 1/136209; G02F 1/136277; G02F 2001/136222; G02F 1/1339; G02F 1/134309; G02F 1/136286

(57) ABSTRACT

A display device includes: a first substrate; a light blocking pattern on the first substrate; a contact electrode on the light blocking pattern; a conductive seal on the contact electrode and in contact with the contact electrode; an opposed electrode on the conductive seal and in contact with the conductive seal; a second substrate on the opposed electrode; and a light blocking member under the opposed electrode, wherein the light blocking member has an opening corresponding to the light blocking pattern, and the conductive seal is electrically coupled to the opposed electrode through the opening.

### CROSS-REFERENCE TO RELATED APPLICATION

This application claims priority to and the benefit of Korean Patent Application No. 10-2018-0090845 filed in the Korean Intellectual Property Office on Aug. 3, 2018, the entire contents of which are incorporated herein by reference.

### BACKGROUND

### 1. Field

Embodiments of the present disclosure relate to a display device.

### 2. Description of the Related Art

A display device such as a liquid crystal display (LCD), an organic light emitting diode (OLED) display, etc. includes a display panel including a plurality of pixels that can display an image. Each pixel includes a pixel electrode configured to receive a data signal, and the pixel electrode is coupled to at least one transistor to receive the data signal.

The display device may include two substrates and a sealant therebetween, and an electrode may be on the two substrates. Among these display devices, the liquid crystal display includes a liquid crystal layer between the two substrates.

The above information disclosed in this Background section is only for enhancement of understanding of the background of the present disclosure, and therefore, it may contain information that does not form the prior art that is already known in this country to a person of ordinary skill in the art.

### SUMMARY

Embodiments of the present disclosure realize an electric connection by a conductive seal while preventing or reducing a display defect due to a short circuit between two substrates by a foreign particle of a display device and to prevent or reduce reflection and unnecessary recognition of light on a part where the conductive seal is located.

A display device according to an exemplary embodiment of the present disclosure includes: a first substrate; a light blocking pattern on the first substrate; a contact electrode on the light blocking pattern; a conductive seal on the contact electrode and in contact (e.g., physical contact) with the contact electrode; an opposed electrode on the conductive seal and in contact (e.g., physical contact) with the conductive seal; a second substrate on the opposed electrode; and a light blocking member under the opposed electrode, wherein the light blocking member has an opening corresponding to the light blocking pattern, and the conductive seal is electrically coupled to the opposed electrode through the opening.

The conductive seal may overlap the light blocking pattern.

In the opening, a lateral surface of the light blocking member may be in contact (e.g., physical contact) with a lateral surface of the conductive seal.

In a plan view, an area of the light blocking pattern may be equal to or larger than an area of the opening.

The light blocking pattern may include at least two color filters representing different colors from each other (e.g., the light blocking pattern may include at least two color filters configured to transmit respective colors that are different from each other).

The at least two color filters may include a red color filter and a blue color filter overlapping each other.

The display device may further include: a transmitting electrode on the first substrate; and an insulating layer on the transmitting electrode, wherein the insulating layer may have a contact hole formed on the transmitting electrode, and the contact electrode may be electrically coupled to the transmitting electrode through the contact hole.

The light blocking pattern may not overlap the contact hole.

In the contact hole, a distance between the contact electrode and an upper surface of the first substrate may be smaller than a distance between the contact electrode on the light blocking pattern and the upper surface of the first substrate.

A sealant between the light blocking member and the contact electrode may be further included.

The display device may include a display area configured to display an image and a peripheral area around the display area, the transmitting electrode, the light blocking pattern, the contact electrode, and the conductive seal may be in the peripheral area, and the transmitting electrode, the light blocking pattern, the contact electrode, and the conductive seal may extend along a first direction.

In a plan view, the first contact hole may be between the light blocking pattern and the display area.

A display device according to an exemplary embodiment includes: a first substrate and a second substrate including a display area configured to display an image and a peripheral area around the display area; a transmitting electrode between the first substrate and the second substrate and in the peripheral area; an insulating layer on the transmitting electrode; a light blocking pattern on the insulating layer and in the peripheral area; a contact electrode on the light blocking pattern and in the peripheral area; a conductive seal on the contact electrode and in the peripheral area; and an opposed electrode between the conductive seal and the second substrate and electrically coupled to the conductive seal, wherein the insulating layer has a contact hole formed on the transmitting electrode, the contact electrode is electrically coupled to the transmitting electrode through the contact hole, and the conductive seal is on the light blocking pattern and does not overlap the contact hole.

In the contact hole, a distance between the contact electrode and an upper surface of the first substrate may be smaller than the distance between the contact electrode on the light blocking pattern and the upper surface of the first substrate.

A light blocking member under the opposed electrode may be further included, the light blocking member may have an opening corresponding to the light blocking pattern, and the conductive seal may be electrically coupled to the opposed electrode through the opening.

In the opening, the lateral surface of the light blocking member may be in contact (e.g., physical contact) with the lateral surface of the conductive seal.

The light blocking pattern may include a red color filter and a blue color filter overlapping each other.

A display device according to an exemplary embodiment includes: a display area configured to display an image and a peripheral area around the display area; a transmitting electrode in the peripheral area and extending along a first direction along an edge of the display area; a contact electrode in the peripheral area, overlapping the transmitting electrode, and extending along the first direction; a light blocking pattern and a conductive seal in the peripheral area, overlapping the contact electrode, and extending along the first direction; an insulating layer between the transmitting electrode and the contact electrode and having a contact hole in a cross-sectional view; and an opposed electrode in contact (e.g., physical contact) with the conductive seal, wherein the light blocking pattern and the conductive seal do not overlap the contact hole in a plan view, and the conductive seal overlaps the light blocking pattern and is in contact (e.g., physical contact) with the contact electrode on the light blocking pattern.

The contact electrode may be electrically coupled to the transmitting electrode through the contact hole.

A light blocking member overlapping the conductive seal and the light blocking pattern and having an opening in the peripheral area may be further included.

According to an exemplary embodiment of the present disclosure, while preventing or reducing the display defect due to the short circuit between two substrates by foreign particles in the display device, an electrical connection by the conductive seal is possible, and reflection of light and unnecessary recognition from the outside of the part where the conductive seal is located may be prevented or reduced.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a layout view of a display device according to an exemplary embodiment,

FIG. 2 is a layout view of two adjacent pixels of a display device according to an exemplary embodiment,

FIG. 3 is a cross-sectional view of the display device shown in FIG. 2 taken along a line IIIa-IIIb,

FIG. 4 is a cross-sectional view of the display device shown in FIG. 1 taken along a line IVa-IVb,

FIG. 5 is an enlarged view of a portion AA of the display device shown in FIG. 1,

FIG. 6 is cross-sectional view of the display device shown in FIG. 5 taken along a line VIa-VIb,

FIG. 7 is cross-sectional view of the display device shown in FIG. 5 taken along a line VIIa-VIIb, and

FIGS. 8-10 are layout views of a display device according to an exemplary embodiment.

### DETAILED DESCRIPTION

The subject matter of the present disclosure will be described more fully hereinafter with reference to the accompanying drawings, in which exemplary embodiments of the present disclosure are shown. As those skilled in the art would realize, the described embodiments may be modified in various different ways, all without departing from the spirit or scope of the present disclosure.

In order to more clearly describe the subject matter of the present disclosure, a description of elements that are not related to the present disclosure will be omitted. Like reference numerals denote like elements throughout the drawings.

In addition, the size and thickness of each configuration shown in the drawings may be arbitrarily shown for better understanding and ease of description, but the present disclosure is not limited thereto. In the drawings, the thickness of layers, films, panels, areas, etc., may be exaggerated for clarity.

It will be understood that when an element such as a layer, film, area, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Throughout this specification, a plan view means a view when observing a surface parallel to two directions (e.g., a first direction DR1 and a second direction DR2) crossing each other, and a cross-sectional view means a view when observing a surface cut in a direction (e.g., a third direction) perpendicular to the surface parallel to the first direction DR1 and the second direction DR2. Also, to overlap two constituent elements means that two constituent elements are overlapped in the third direction (e.g., a direction perpendicular to an upper surface of the substrate) unless stated otherwise.

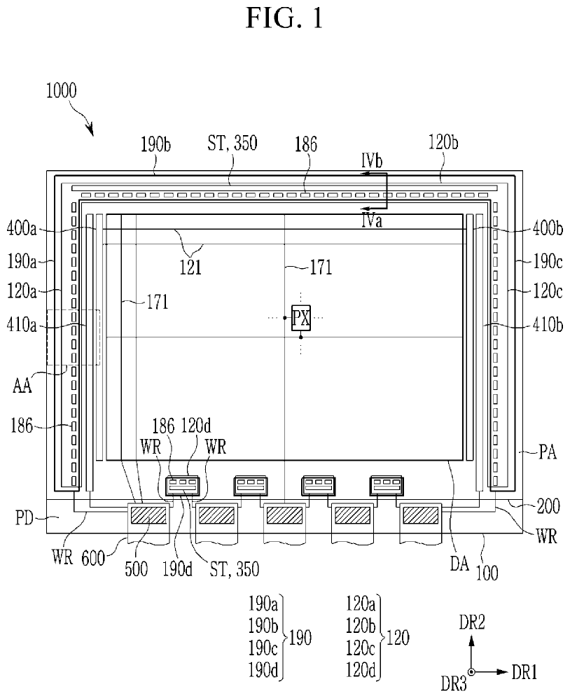

Now, a display device according to an exemplary embodiment is described with reference to FIGS. 1-7. For convenience of the description, a plan structure of the entire display device is firstly described with reference to FIG. 1, and then a cross-sectional structure of the display device is described with reference to the remainder of the drawings.

FIG. 1 is a layout view of a display device according to an exemplary embodiment.

Referring to FIG. 1, a display device 1000 according to an exemplary embodiment includes a first display panel 100 and a second display panel 200 facing and overlapping each other in a plan view. In a plan view, the first display panel 100 may include a pad area PD that is not covered by the second display panel 200.

The display device 1000 includes a display area DA as an area configured to display an image and a peripheral area PA around the display area DA. For example, in the display device 1000, the area where the first display panel 100 (or the substrate included in the first display panel 100) and the second display panel 200 (or the substrate included in the second display panel 200) overlap each other may include the display area DA configured to display the image and the peripheral area PA around the display area DA.

A plurality of pixels PX and a plurality of signal lines are in the display area DA. The edge of the display area DA may extend to be almost parallel (e.g., substantially parallel) to the first direction DR1 and the second direction DR2.

Each pixel PX as a unit configured to display an image may represent light of a gray representing an image signal corresponding to each pixel (e.g., may emit light corresponding to an image signal to thereby display an image). Each pixel PX may have a light transmission area where light may be transmitted spatially and a light blocking area where light is blocked, and may include at least one transistor. The transistor may be mainly on the light blocking area of each pixel PX, however, it is not limited thereto. Each pixel PX may represent (e.g., emit) a primary color such as red, green, and blue. The plurality of pixels PX may be arranged in an approximate matrix, but are not limited thereto.

The plurality of signal lines may include a plurality of gate lines 121 configured to transmit a gate signal and a plurality of data lines 171 configured to transmit a data signal. At least one transistor included in each pixel PX may be electrically coupled to the corresponding gate line 121 and data line 171. Each gate line 121, for example, may extend along the first direction DR1 and may be elongated to the peripheral area PA. Each data line 171 crosses the plurality of gate lines 121, and for example, may extend in the second direction DR2. Each data line 171 may also extend to the peripheral area PA.

In the peripheral area PA of the first display panel 100, gate drivers 400a and 400b, driving signal wires 410a and 410b, a transmitting electrode 120, a contact electrode 190, a light blocking pattern ST, a conductive seal 350, etc. are located.

The gate drivers 400a and 400b may be coupled to the plurality of gate lines 121 to apply the gate signal to the gate lines 121. The gate drivers 400a and 400b may be formed together in the same manufacturing process with the plurality of signal lines and the transistor in the display area DA. FIG. 1 shows an example in which the gate drivers 400a and 400b are respectively on right/left sides based on the display area DA, however it is not limited thereto, and the gate driver 400a or 400b may only be on one side based on the display area DA.

The driving signal wires 410a and 410b may be located at a position adjacent to each of the gate drivers 400a and 400b and may be coupled to the gate drivers 400a and 400b, thereby transmitting the driving signal to the gate drivers 400a and 400b. The driving signal wires 410a and 410b, for example, may include a clock signal wire. Each of the driving signal wires 410a and 410b may extend in the approximate second direction DR2.

As shown in FIG. 1, each of the gate drivers 400a and 400b may be between each of the driving signal wires 410a and 410b and the edge of the display area DA, or in some embodiments, the driving signal wires 410a and 410b may be between each of the gate drivers 400a and 400b and the display area DA.

The transmitting electrode 120 may include a transmitting electrode part 120a at the left based on the display area DA, a transmitting electrode part 120b at the upper side, a transmitting electrode part 120c at the right, and at least one transmitting electrode part 120d at the lower side. The transmitting electrode parts 120a, 120b, 120c, and 120d may be on the same layer and may include the same (e.g., substantially the same) material as each other.

As shown in FIG. 1, the transmitting electrode parts 120a, 120b, and 120c may be coupled to each other to form one electrode. Thus, the coupled transmitting electrode parts 120a, 120b, and 120c may form an approximate ‘=’ shape.

The at least one transmitting electrode part 120d is separated from the transmitting electrode parts 120a, 120b, and 120c. When the transmitting electrode part 120d is plural (e.g., when there is a plurality of the transmitting electrode part 120d), the plurality of transmitting electrode parts 120d may be separated from each other. The plurality of transmitting electrode parts 120d may be approximately arranged in the first direction DR1 in the lower peripheral area PA of the display area DA.

The contact electrode 190 is on a different layer from that of the transmitting electrode 120, and overlaps the transmitting electrode 120. In more detail, the contact electrode 190 may include a contact electrode part 190a overlapping the transmitting electrode part 120a, a contact electrode part 190b overlapping the transmitting electrode part 120b, a contact electrode part 190c overlapping the transmitting electrode part 120c, and at least one contact electrode part 190d overlapping the transmitting electrode part 120d. The contact electrode parts 190a, 190b, 190c, and 190d may be on the same layer and may include the same (e.g., substantially the same) material as each other.

The contact electrode parts 190a, 190b, and 190c may be coupled to form one electrode. The coupled contact electrode parts 190a, 190b, and 190c may form the approximate ‘⊏’ shape.

The at least one contact electrode part 190d is separated from the contact electrode parts 190a, 190b, and 190c. When the contact electrode part 190d is plural (e.g., when there is a plurality of the transmitting electrode part 120d), the plurality of contact electrode parts 190d may be separated from each other. The plurality of contact electrode parts 190d may be approximately arranged in the first direction DR1 in the lower peripheral area PA of the display area DA.

The contact electrode 190 may be electrically coupled to the transmitting electrode 120 through a plurality of contact holes 186 overlapping the transmitting electrode 120. As shown in FIG. 1, the plurality of contact holes 186 may be arranged along the edge of the contact electrode 190 or the transmitting electrode 120.

As shown in FIG. 1, the area where the contact electrode 190 is not formed may be between the edge of the first display panel 100 and the contact electrode 190, and in some embodiments, the contact electrode 190 may be formed to the edge of the first display panel 100.

Inflowing static electricity may be dispersed through the contact electrode 190 and the transmitting electrode 120 coupled thereto near the edge of the display device 1000, so damage to the electric element due to the static electricity inflow may be prevented or reduced.

The light blocking pattern ST and the conductive seal 350 overlap the contact electrode 190 in a plan view, and may also overlap the transmitting electrode 120. FIG. 1 shows an example in which the light blocking pattern ST and the conductive seal 350 overlap the transmitting electrode 120. The light blocking pattern ST may overlap most of the conductive seal 350 in a plan view. For example, in a plan view, most of the area where the conductive seal 350 is located may be covered by the light blocking pattern ST.

In a plan view, the light blocking pattern ST and the conductive seal 350 may be separated from each other without overlapping the contact hole 186. The contact hole 186 may be between the area of the light blocking pattern ST and the conductive seal 350, and the edge of the display area DA.

Referring to FIG. 1, the light blocking pattern ST and the conductive seal 350 may include an upper part overlapping the contact electrode part 190b at the upper side based on the display area DA, and a lower part overlapping at least one contact electrode part 19 at the lower side based on the display area DA. Each of the upper part and the lower part of the light blocking pattern ST and the conductive seal 350 may extend parallel (e.g., substantially parallel) to the first direction DR1 along the direction that the contact electrode parts 190b and 190d extend.

As shown in FIG. 1, the light blocking pattern ST and the conductive seal 350 may not be on the left and the right based on the display area DA. However, according to another exemplary embodiment, the light blocking pattern ST and the conductive seal 350 may be formed on the left part and/or the right part respectively overlapping the contact electrode parts 190a and 190c at the left and/or the right based on the display area DA.

The pad area PD of the first display panel 100 may be under the peripheral area PA at the lower side based on the display area DA. A plurality of pads may be in the pad area PD, and the plurality of pads may be electrically coupled to at least one circuit film 600. At least one data driver 500 may be on at least one circuit film 600. FIG. 1 shows an example in which each data driver 500 is on each of a plurality of circuit films 600. The data driver 500 may include at least one IC chip.

The plurality of data lines 171 may extend into the peripheral area PA to be coupled to the data driver 500, thereby receiving the data signal.

The transmitting electrode 120 on the first display panel 100 may be electrically coupled to the data driver 500 through a signal wire WR in the pad area PD, thereby receiving the common voltage. In some embodiments, the transmitting electrode 120 may be coupled to the circuit film 600 or a separate driver on a circuit board coupled to the circuit film 600 to receive the common voltage.

When the display device 1000 includes a plurality of data drivers 500, the transmitting electrode part 120d at the lower side based on the display area DA may be in the peripheral area PA corresponding to between two adjacent data drivers 500. The transmitting electrode part 120d, as shown in FIG. 1, may be coupled to two data drivers 500 directly adjacent to the transmitting electrode part 120d through the signal wire WR, and in some embodiments, it may be only coupled to one data driver 500.

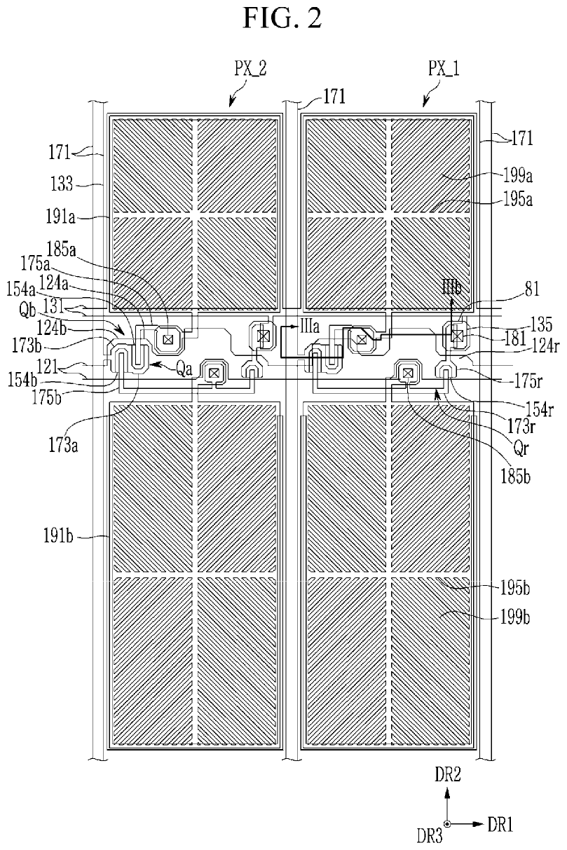

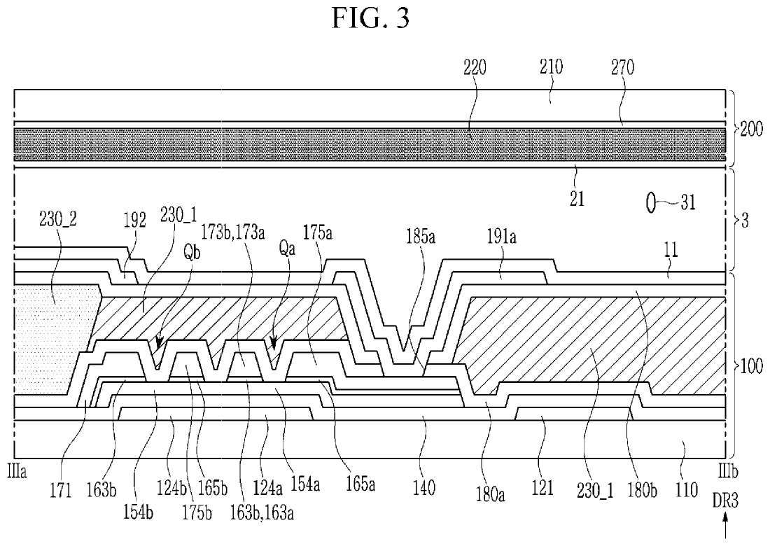

FIG. 2 is a layout view of two adjacent pixels PX_1 and PX_2 of a display device according to an exemplary embodiment, and FIG. 3 is a cross-sectional view of the display device shown in FIG. 2 taken along a line IIIa-IIIb. In FIG. 2, reference numerals are divided into and indicate two pixels PX_1 and PX_2, however the reference numerals indicating one pixel PX_1 or PX_2 may be also equally applied to the other pixel PX_2 or PX_1.

Referring to FIG. 2 along with FIG. 1, the display device 1000 according to an exemplary embodiment may include a liquid crystal layer 3 as one example of a light conversion layer between the first display panel 100 and the second display panel 200.

The first display panel 100 may include a gate conductive layer including a plurality of gate lines 121 and a reference voltage line 131 on a substrate 110. The gate line 121 may include a first gate electrode 124a, a second gate electrode 124b, and a third gate electrode 124r. The reference voltage line 131 may be separated from the gate line 121 and may transmit the reference voltage. The reference voltage line 131 may include protrusions 133 and 135 protruded upward or downward from the part extending in the first direction DR1.

A gate insulating layer 140 is on the gate conductive layer, and the semiconductor layer including a first semiconductor 154a, a second semiconductor 154b, and a third semiconductor 154r is on the gate insulating layer 140. The first semiconductor 154a and the second semiconductor 154b may be coupled to each other. The first semiconductor 154a may overlap the first gate electrode 124a, the second semiconductor 154b may overlap the second gate electrode 124b, and the third semiconductor 154r may overlap the third gate electrode 124r. The semiconductor layer may include amorphous silicon, polycrystalline silicon, a metal oxide, etc.

Ohmic contacts 163a, 163b, 165a, and 165b may be on the semiconductor layer. The ohmic contacts 163a, 163b, 165a, and 165b may be formed of a material such as n+ hydrogenated amorphous silicon in which an n-type impurity is doped with a high concentration, or of a silicide. In some embodiments, the ohmic contacts 163a, 163b, 165a, and 165b may be omitted.

A data conductive layer including a plurality of data lines 171 including a first source electrode 173a and a second source electrode 173b, a first drain electrode 175a, a second drain electrode 175b, a third source electrode 173r, and a third drain electrode 175r is on the ohmic contacts 163a, 163b, 165a, and 165b.

The first source electrode 173a and the second source electrode 173b are coupled to each other, and the second drain electrode 175b and the third source electrode 173r are coupled to each other. The third source electrode 173r and the third drain electrode 175r face each other. One end that does not face the third source electrode 173r among ends of the third drain electrode 175r may be adjacent to or overlap the part of the protrusion 135 of the reference voltage line 131.

The first gate electrode 124a, the first source electrode 173a, and the first drain electrode 175a form the first transistor Qa along with the first semiconductor 154a, the second gate electrode 124b, the second source electrode 173b, and the second drain electrode 175b form the second transistor Qb along with the second semiconductor 154b, and the third gate electrode 124r, the third source electrode 173r, and the third drain electrode 175r form the third transistor Qr along with the third semiconductor 154r.

The gate line 121, the reference voltage line 131, and the first to third thin film transistors Qa, Qb, and Qr may be in the light blocking area of the pixels PX_1 and PX_2.

A first insulating layer 180a may be on the data conductive layer and the semiconductor layer. The first insulating layer 180a may include the organic insulating material and/or the inorganic insulating material, and may be formed of a single layer or a multilayer.

A plurality of color filters 230_1 and 230_2 may be on the first insulating layer 180a. The plurality of color filters may include a first color filter 230_1 representing (e.g., configured to transmit) a first color and a second color filter 230_2 representing (e.g., configured to transmit) a second color that is different from the first color. Each of the plurality of color filters may represent (e.g., may be configured to transmit) one among the primary colors such as three primary colors of red, green, and blue, or four primary colors. For example, the first color filter 230_1 represents (e.g., is configured to transmit) red, the second color filter 230_2 represents (e.g., is configured to transmit) blue, and in some embodiments, another color filter may represent (e.g., may be configured to transmit) green.

Referring to FIG. 1, when the plurality of pixels PX are arranged in the matrix shape, the pixels PX on the same column may be arranged to correspond to one color filter, and the color filters of the different colors from each other may be in the adjacent pixel columns.

A second insulating layer 180b may be on the color filters 230_1 and the 230_2. The second insulating layer 180b may include the inorganic insulating material and/or the organic insulating material. The second insulating layer 180b may be omitted.

The first insulating layer 180a and the second insulating layer 180b may include a contact hole 185a formed on the first drain electrode 175a and a contact hole 185b formed on the second drain electrode 175b. The contact holes 185a and 185b may be respectively formed in openings where parts of the color filters 230_1 and 230_2 are removed.

The gate insulating layer 140 and the first and second insulating layers 180a and 180b may further have a contact hole 181 exposing a part of the third drain electrode 175r and a part of the protrusion 135 of the reference voltage line 131 together.

A pixel electrode layer including a plurality of pixel electrodes (191a and 191b), a shielding electrode 192, and a plurality of contact assistants 81 may be on the second insulating layer 180b. The pixel electrode (191a and 191b) corresponding to one pixel of PX, PX_1, and PX_2 may be formed of one electrode and may include a plurality of sub-pixel electrodes. In the present exemplary embodiment, an example in which one pixel electrode (191a and 191b) includes a first sub-pixel electrode 191a and a second sub-pixel electrode 191b is mainly described.

For example, the first sub-pixel electrode 191a and the second sub-pixel electrode 191b may be on opposite sides via the gate line 121, the reference voltage line 131, and the first to third transistors Qa, Qb, and Qr. However, the arrangement and the shape of the first sub-pixel electrode 191a and the second sub-pixel electrode 191b are not limited to as shown above, and may be variously changed.

The first sub-pixel electrode 191a and the second sub-pixel electrode 191b may respectively include a stem 195a and 195b of a crossed shape and a plurality of branches 199a and 199b.

The first sub-pixel electrode 191a and the second sub-pixel electrode 191b are electrically coupled to the first drain electrode 175a and the second drain electrode 175b through the contact holes 185a and 185b, respectively. The first sub-pixel electrode 191a may receive the data voltage from the first drain electrode 175a, and the second sub-pixel electrode 191b may receive a divided voltage between the data voltage transmitted through the second drain electrode 175b and the reference voltage transmitted by the reference voltage line 131.

The shielding electrode 192 is separated from the pixel electrode (191a and 191b), mainly extends in the second direction DR2 to overlap the data line 171, and may be arranged corresponding to between two pixels PX_1 and PX_2.

The third drain electrode 175r and the protrusion 135 of the reference voltage line 131 may be coupled to each other through the contact assistants 81 in the contact hole 181.

The pixel electrode layer may include a transparent conductive material such as ITO, IZO, a metal thin film, etc.

An alignment layer 11 adjacent to the liquid crystal layer 3 may be on the pixel electrode layer. The alignment layer may be a vertical alignment layer.

In describing the second display panel 200, an opposed electrode 270 may be under a substrate 210 (referred to as a side toward the first display panel 100). The opposed electrode 270 with a planar shape may be formed such that it is to the entire (e.g., substantially the entire) second display panel 200. For example, the opposed electrode 270 may be in the peripheral area PA as well as the display area DA, and may be formed to the edge of the substrate 210. The opposed electrode 270 may transmit the common voltage. The opposed electrode 270 is also referred to as a common electrode. The opposed electrode 270 may include the transparent conductive material such as ITO, IZO, the metal thin film, etc.

A light blocking member 220 is under the opposed electrode 270. For example, the opposed electrode 270 is between the light blocking member 220 and the substrate 210. The light blocking member 220 may include a light blocking part overlapping the transistors Qa, Qb, and Qr included in each pixel PX, PX_1, and PX_2, and the gate line 121 in the display area DA and a surrounding light blocking part in the peripheral area PA. The light blocking member 220 may include a pigment such as carbon black, etc.

An alignment layer 21 adjacent to the liquid crystal layer 3 may be under the light blocking member 220. The alignment layer 21 may be the vertical alignment layer.

The liquid crystal layer 3 includes a plurality of liquid crystal molecules 31.

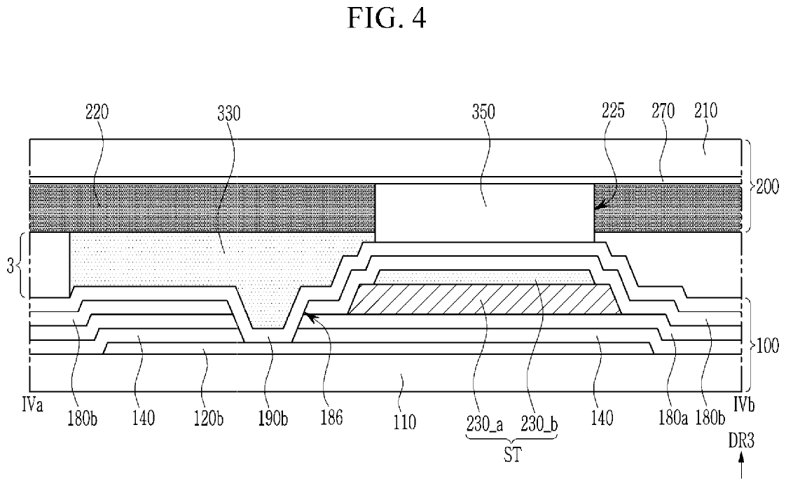

FIG. 4 is a cross-sectional view of the display device shown in FIG. 1 taken along a line IVa-IVb.

Referring to FIG. 4 along with the above-described drawings, the above-described gate conductive layer may include the above-described transmitting electrode 120. For example, in the peripheral area PA of the display device 1000, such as the peripheral area PA of the left side, the right side, and the upper side that are not adjacent to the pad area PD, the transmitting electrode 120 including the transmitting electrode parts 120a, 120b, 120c, and 120d may be on the substrate 110 of the first display panel 100.

The gate insulating layer 140 and the first insulating layer 180a are sequentially on the transmitting electrode 120.

The light blocking pattern ST is on the first insulating layer 180a. The light blocking pattern ST may block most of the light. The light blocking pattern ST includes at least two color filters 230_a and 230_b representing (e.g., configured to transmit) different colors from each other among the plurality of color filters. In some embodiments, for the light blocking effect, at least two color filters 230_a and 230_b included in the light blocking pattern ST may include the red color filter representing (e.g., configured to transmit) red and the blue color filter representing (e.g., configured to transmit) blue. For example, the color filter 230_a included in the light blocking pattern ST may represent (e.g., may be configured to transmit) red and the color filter 230_b thereon may represent (e.g., may be configured to transmit) blue, or it may be the reverse. The color filter 230_a may be formed on the same layer and in the same process as the above-described first color filter 230_1, and the color filter 230_b may be formed on the same layer and in the same process as the above-described second color filter 230_2.

In the light blocking pattern ST, the plan area of the color filter 230_a located closer to the substrate 110 may be larger than the plan area of the color filter 230_b thereon.

As described above, the light blocking pattern ST including at least two color filters 230_a and 230_b sequentially deposited forms a high step part from the substrate 110 as compared with the periphery. The light blocking pattern ST, as shown in FIG. 4, may only include two color filters 230_a and 230_b respectively representing (e.g., respectively configured to transmit) red and blue.

The second insulating layer 180b may be on the first insulating layer 180a and the light blocking pattern ST.

The gate insulating layer 140, the first insulating layer 180a, and the second insulating layer 180b have a plurality of contact holes 186 formed on the transmitting electrode 120. At least some of the plurality of contact holes 186 may be coupled to each other.

The pixel electrode layer on the second insulating layer 180b may include the contact electrode 190 including contact electrode parts 190a, 190b, 190c, and 190d. As described above, the contact electrode 190 is in contact (e.g., physical contact) with and electrically coupled to the transmitting electrode 120 in the gate conductive layer through the contact hole 186, and is thereby configured to receive the common voltage.

As described above, the light blocking pattern ST does not overlay and is adjacent to the contact hole 186. In other words, the light blocking pattern ST is not on the contact hole 186. Accordingly, as shown in FIG. 4, the contact electrode 190 overlapping the transmitting electrode 120 and on the transmitting electrode 120 may be arranged to be lowest at the position of the contact hole 186 and to be highest at the position of the light blocking pattern ST. In the contact hole 186, the shortest distance between the contact electrode 190 and the upper surface of the substrate 110 is smaller than the shortest distance between the contact electrode 190 on the light blocking pattern ST and the upper surface of the substrate 110. Here, the shortest distance with the upper surface of the substrate 110 may be a distance in the third direction DR3.

A sealant 330 that seals the liquid crystal layer 3 is between the first display panel 100 and the second display panel 200. The sealant 330 may be in the peripheral area PA shown in FIG. 1, and may have a closed loop shape enclosing the display area DA. The sealant 330 may include a part on the contact hole 186 and overlapping the contact hole 186.

The conductive seal 350 overlapping the light blocking pattern ST is on the contact electrode 190. The lower surface of the conductive seal 350 is in contact (e.g., physical contact) with the contact electrode 190 to be electrically coupled to the contact electrode 190, and the upper surface of the conductive seal 350 is in contact (e.g., physical contact) with the opposed electrode 270 of the second display panel 200 on the conductive seal 350 to be electrically coupled to the opposed electrode 270. Accordingly, the opposed electrode 270 may receive the common voltage from the contact electrode 190 in the first display panel 100 through the conductive seal 350. The conductive seal 350 may include a conductive ball, and is referred to as a short seal.

The light blocking member 220 of the peripheral area PA has an opening 225 corresponding to the area where the conductive seal 350 is located, and the conductive seal 350 is in the opening 225 to be coupled to the opposed electrode 270 through the opening 225 so that the conductive seal 350 is in contact (e.g., physical contact) with the opposed electrode 270. The light blocking member 220 may be completely (or substantially completely) removed in the opening 225. The lateral surface of the light blocking member 220 in the opening 225 may be in contact (e.g., physical contact) with the lateral surface of the conductive seal 350.

In the present exemplary embodiment, the opposed electrode 270 of the second display panel 200 may be between the light blocking member 220 and the substrate 210. Accordingly, the display defect due to the short circuit by the foreign particles between the electrode (e.g., the electrode in the pixel electrode layer) in the first display panel 100 and the opposed electrode 270 may be prevented or reduced.

In this case, for the conductive connection (e.g., the short, or short circuit) between the opposed electrode 270 and the contact electrode 190 by the conductive seal 350, as described above, the conductive seal 350 may be in contact (e.g., physical contact) with the opposed electrode 270 through the opening 225 of the light blocking member 220. Also, since the conductive seal 350 is on the light blocking pattern ST forming the step part, the conductive seal 350 may be in contact (e.g., physical contact) with the opposed electrode 270 by passing through the thickness of the light blocking member 220, and accordingly an electrical connection between the opposed electrode 270 and the contact electrode 190 is possible. Here, the thickness may mean a thickness in the third direction DR3. For this, the thickness of the light blocking pattern ST may be similar to the thickness of the light blocking member 220. However, the thickness of the light blocking pattern ST, the thickness of the conductive seal 350, and the thickness of the light blocking member 220 may be suitably or appropriately adjusted to electrically couple the contact electrode 190 and the opposed electrode 270 to each other through the conductive seal 350.

In a plan view, the opening 225 of the light blocking member 220 or the conductive seal 350 overlaps the light blocking pattern ST and is covered by the light blocking pattern ST, thereby being shielded. In a plan view, the area of the light blocking pattern ST may be equal to or larger than the area of the opening 225 of the light blocking member 220 or the conductive seal 350. Since the light blocking pattern ST is arranged corresponding to the opening 225 of the light blocking member 220, recognition from the outside of or reflection of light by the gate conductor such as the transmitting electrode 120 under the light blocking pattern ST may be prevented or reduced.

In the exposure process for forming the conductive seal 350, since the light irradiated from the second display panel 200 reaches the conductive seal 350 through the opening 225 of the light blocking member 220, it is not necessary to irradiate the light at the first display panel 100 side. Accordingly, the transmitting electrode 120 may not have an opening such as a separate slit on the inside area.

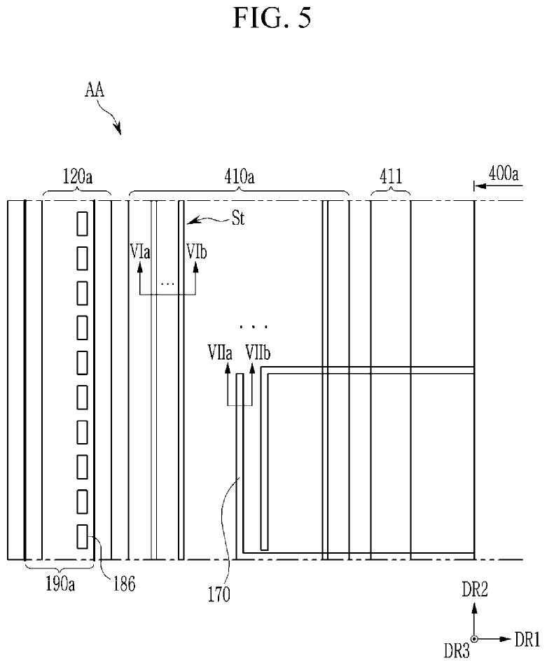

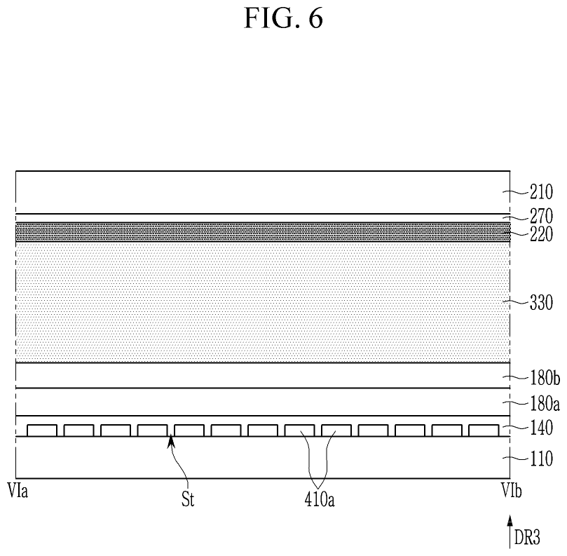

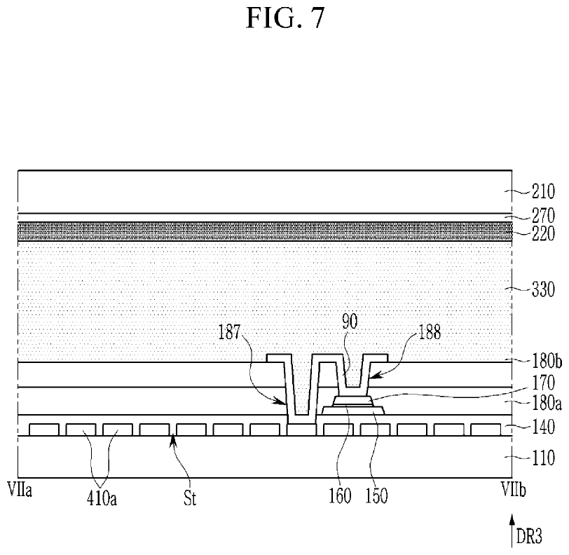

FIG. 5 is an enlarged view of a portion AA of the display device shown in FIG. 1, FIG. 6 is cross-sectional view of the display device shown in FIG. 5 taken along a line VIa-VIb, and FIG. 7 is cross-sectional view of the display device shown in FIG. 5 taken along a line VIIa-VIIb,

FIGS. 5-7 representatively show the peripheral area PA on the left of the display device 1000 shown in FIG. 1, and the same (e.g., substantially the same) structure thereof may also be applied to the peripheral area PA on the right of the display device 1000.

The above-described gate conductive layer may further include driving signal wires 410a and 410b and voltage wiring 411. The voltage wiring 411 may transmit a low voltage used to generate the gate signal in the gate drivers 400a and 400b. The voltage wiring 411 may be between the driving signal wires 410a and 410b and the gate drivers 400a and 400b.

The sealant 330 may overlap the driving signal wires 410a and 410b, and the driving signal wires 410a and 410b may include a plurality of slits St. Each slit St may extend in the second direction DR2.

The above-described data conductive layer may further include connection wiring 170 overlapping the driving signal wires 410a and 410b. The connection wiring 170 may include a part extending from the driving signal wires 410a and 410b to the gate drivers 400a and 400b. A semiconductor 150 and an ohmic contact 160 in the semiconductor layer may be under the connection wiring 170.

The gate insulating layer 140, the first insulating layer 180a, and the second insulating layer 180b on the driving signal wires 410a and 410b have a contact hole 187 on the driving signal wires 410a and 410b, and the first insulating layer 180a and the second insulating layer 180b may have a contact hole 188 on the connection wiring 170.

The above-described pixel electrode layer may further include a connecting member 90 on the second insulating layer 180b. The connecting member 90 is electrically coupled to the driving signal wires 410a and 410b and the connection wiring 170 through the contact holes 187 and 188. Accordingly, since the driving signal wires 410a and 410b and the connection wiring 170 are electrically coupled to each other, the driving signal such as the clock signal transmitted by the driving signal wires 410a and 410b through the connection wiring 170 may be transmitted to the gate drivers 400a and 400b.

As described above, according to the present exemplary embodiment, since the opposed electrode 270 of the second display panel 200 is between the light blocking member 220 and the substrate 210, generation of the display defect due to the short circuit by the foreign particle between the connecting member 90 and the opposed electrode 270 may be prevented or reduced.

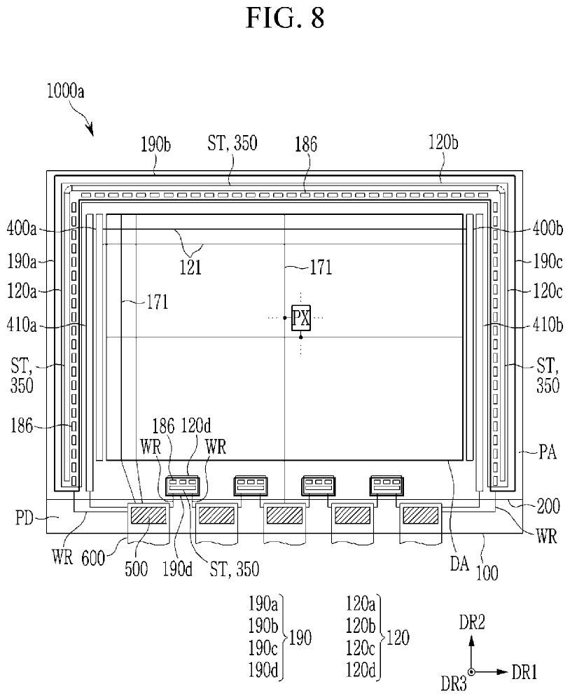

FIGS. 8-10 are layout views of a display device according to an exemplary embodiment.

First referring to FIG. 8, a display device 1000a according to the exemplary embodiment shown in FIG. 8 is substantially the same as most of the above-described display device 1000, however the light blocking pattern ST and the conductive seal 350 may be different. The light blocking pattern ST and the conductive seal 350 may further include a left part overlapping the contact electrode part 190a at the left based on the display area DA and a right part overlapping the contact electrode part 190c at the right based on the display area DA, as well as the parts shown in FIG. 1. Each of the left part and the right part may extend approximately parallel (e.g., substantially parallel) to the second direction DR2 along the extending direction of the contact electrode parts 190a and 190c.

The left part and the right part of the light blocking pattern ST and the conductive seal 350 may not be coupled to the upper part overlapping the contact electrode part 190b, and as indicated by a dotted line in FIG. 8, they may be coupled to the upper part to couple the light blocking pattern ST and the conductive seal 350 to one on the left, the upper, and the right based on the display area DA.

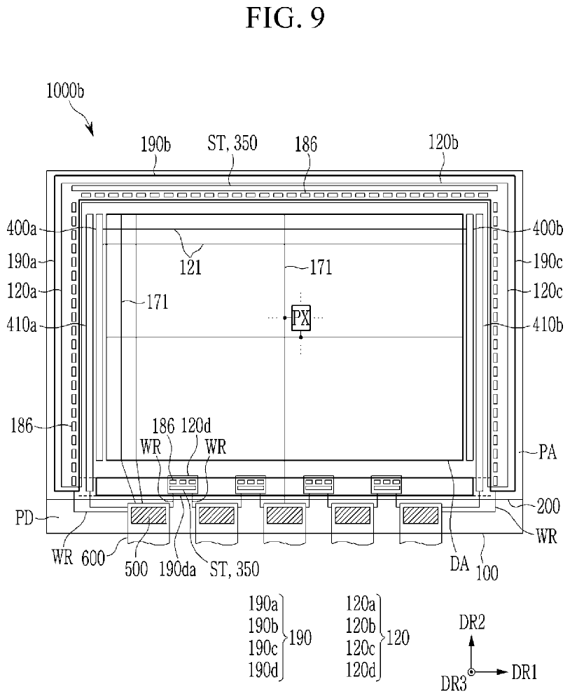

Referring to FIG. 9, a display device 1000b according to the exemplary embodiment shown in FIG. 9 is substantially the same as most of the above-described display device 1000, however the contact electrode part 190d of the contact electrode 190 may be different. Instead of the plurality of contact electrode parts 190d in the peripheral area PA under the display area DA, one contact electrode part 190da extending in the first direction DR1 may be located. The contact electrode part 190da may overlap a plurality of transmitting electrode parts 120d.

The contact electrode part 190da may not be coupled to the contact electrode parts 190a and 190c, and the contact electrode part 190da indicated by the dotted line in FIG. 9 may be coupled to the contact electrode parts 190a and 190c. Accordingly, the contact electrode parts 190a, 190b, 190c, and 190da may form a closed loop together enclosing the display area DA.

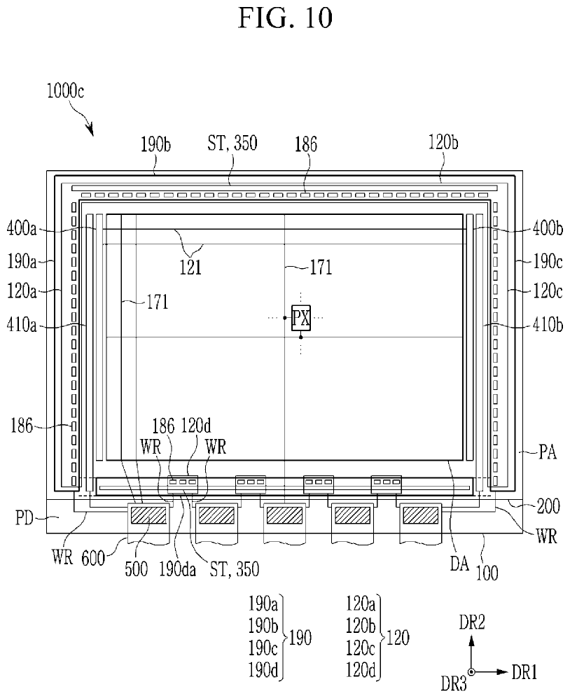

Next, referring to FIG. 10, a display device 1000c according to the exemplary embodiment shown in FIG. 10 is substantially the same as most of the above-described display device 1000b, however, the light blocking pattern ST and the conductive seal 350 may be different. The light blocking pattern ST and the conductive seal 350 in the peripheral area PA under the display area DA have the lower part overlapping the contact electrode part 190da, and the lower part may extend parallel (e.g., substantially parallel) to the first direction DR1 along the extending direction of the contact electrode part 190da.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. As used herein, the term “and/or” includes any and all combinations of one or more of the associated listed items. Expressions such as “at least one of,” when preceding a list of elements, modify the entire list of elements and do not modify the individual elements of the list.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the subject matter of the present disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims, and equivalents thereof.

### DESCRIPTION OF SOME OF THE SYMBOLS

3: liquid crystal layer
100: lower panel (or first display panel)
120: transmitting electrode
180a, 180b: insulating layer
190: contact electrode
200: upper panel (or second display panel)
220: light blocking member
225: opening
230_1, 230_2, 230_a, 230_b: color filter
270: opposed electrode
330: sealant
350: conductive seal
ST: light blocking pattern

What is claimed is:

1. A display device comprising:
a first substrate;
a light blocking pattern on the first substrate;
a contact electrode on the light blocking pattern;
a conductive seal on the contact electrode and in contact with the contact electrode;
an opposed electrode on the conductive seal and in contact with the conductive seal;
a second substrate on the opposed electrode; and
a light blocking member under the opposed electrode,
wherein the light blocking member has an opening corresponding to the light blocking pattern, and
the conductive seal is electrically coupled to the opposed electrode through the opening.

2. The display device of claim 1, wherein:
the conductive seal overlaps the light blocking pattern.

3. The display device of claim 2, wherein:
in the opening, a lateral surface of the light blocking member is in contact with a lateral surface of the conductive seal.

4. The display device of claim 3, wherein:
in a plan view, an area of the light blocking pattern is equal to or larger than an area of the opening.

5. The display device of claim 2, wherein:
the light blocking pattern comprises at least two color filters configured to transmit respective colors that are different from each other.

6. The display device of claim 5, wherein:
the at least two color filters comprise a red color filter and a blue color filter overlapping each other.

7. The display device of claim 2, further comprising:
a transmitting electrode on the first substrate; and
an insulating layer on the transmitting electrode,
wherein the insulating layer has a contact hole on the transmitting electrode, and
the contact electrode is electrically coupled to the transmitting electrode through the contact hole.

8. The display device of claim 7, wherein:
the light blocking pattern does not overlap the contact hole.

9. The display device of claim 8, wherein:
in the contact hole, a distance between the contact electrode and an upper surface of the first substrate is smaller than a distance between the contact electrode on the light blocking pattern and the upper surface of the first substrate.

10. The display device of claim 8, further comprising:
a sealant between the light blocking member and the contact electrode.

11. The display device of claim 7, wherein:
the display device comprises a display area configured to display an image and a peripheral area around the display area;
the transmitting electrode, the light blocking pattern, the contact electrode, and the conductive seal are in the peripheral area; and
the transmitting electrode, the light blocking pattern, the contact electrode, and the conductive seal extend along a first direction.

12. The display device of claim 11, wherein:
in a plan view, the first contact hole is between the light blocking pattern and the display area.

13. A display device comprising:
a first substrate and a second substrate including a display area configured to display an image and a peripheral area around the display area;
a transmitting electrode between the first substrate and the second substrate and in the peripheral area;
an insulating layer on the transmitting electrode;
a light blocking pattern on the insulating layer and in the peripheral area;
a contact electrode on the light blocking pattern and in the peripheral area;
a conductive seal on the contact electrode and in the peripheral area; and
an opposed electrode between the conductive seal and the second substrate and electrically coupled to the conductive seal,
wherein the insulating layer has a contact hole formed on the transmitting electrode,
the contact electrode is electrically coupled to the transmitting electrode through the contact hole, and
the conductive seal is on the light blocking pattern and does not overlap the contact hole.

14. The display device of claim 13, wherein:
in the contact hole, a distance between the contact electrode and an upper surface of the first substrate is smaller than a distance between the contact electrode on the light blocking pattern and the upper surface of the first substrate.

15. The display device of claim 14, further comprising:
a light blocking member under the opposed electrode,
wherein the light blocking member has an opening corresponding to the light blocking pattern, and
the conductive seal is electrically coupled to the opposed electrode through the opening.

16. The display device of claim 15, wherein:
in the opening, a lateral surface of the light blocking member is in contact with a lateral surface of the conductive seal.

17. The display device of claim 13, wherein:
the light blocking pattern comprises a red color filter and a blue color filter overlapping each other.

18. A display device comprising:
a display area configured to display an image and a peripheral area around the display area;
a transmitting electrode in the peripheral area and extending along a first direction along an edge of the display area;
a contact electrode in the peripheral area, overlapping the transmitting electrode, and extending along the first direction;
a light blocking pattern and a conductive seal in the peripheral area, overlapping the contact electrode, and extending along the first direction;
an insulating layer between the transmitting electrode and the contact electrode and having a contact hole in a cross-sectional view; and
an opposed electrode in contact with the conductive seal,
wherein the light blocking pattern and the conductive seal do not overlap the contact hole in a plan view, and
the conductive seal overlaps the light blocking pattern and is in contact with the contact electrode on the light blocking pattern.

19. The display device of claim 18, wherein:
the contact electrode is electrically coupled to the transmitting electrode through the contact hole.

20. The display device of claim 19, further comprising:
a light blocking member overlapping the conductive seal and the light blocking pattern and having an opening in the peripheral area.
